(19) United States
(12) Patent Application Publication
(10) Pub. No.: US 2011/0240750 A1
(43) Pub. Date: Oct. 6, 2011

(54) PERSON-SENSITIVE SENSOR AND AIR CONDITIONER PROVIDED WITH THE SAME

(75) Inventor: Seiji Tokura, Kanagawa-ken (JP)

(73) Assignee: KABUSHIKI KAISHA TOSHIBA, Tokyo (JP)

(21) Appl. No.: 12/880,722

(22) Filed: Sep. 13, 2010

(30) Foreign Application Priority Data
Mar. 31, 2010 (JP) P2010-084320

(51) Int. Cl. G05D 23/00; G01S 13/04

(52) U.S. Cl. 236/51; 342/27

(57) ABSTRACT

In one embodiment, a person-sensitive sensor is provided. The person-sensitive sensor has a Doppler sensor module, a storage unit, a signal intensity comparison unit, a variance value comparison unit and a presumption unit. The storage unit stores signal intensities of a signal outputted from the Doppler sensor module. The signal intensity comparison unit compares whether or not a value of the signal intensities is greater than a first threshold value. The variance value comparison unit compares whether or not a variance value of a part of the signal intensities is greater than a second threshold value. The presumption unit presumes a state of person in a space in which the Doppler sensor module is installed, based on comparison results.

### CROSS-REFERENCE TO RELATED APPLICATION(S)

This application is based upon and claims the benefit of priority from the prior Japanese Patent Application No. 2010-84320, filed on Mar. 31, 2010, the entire contents of which are incorporated herein by reference.

### FIELD

Embodiments described herein relate generally to a person-sensitive sensor and to an air conditioner provided with a person-sensitive sensor.

### BACKGROUND

Air conditioners and monitoring devices, which determine whether or not person is present by using a Doppler sensor, are known. For example, JP-A 2005-241104 (KOKAI) discloses an air conditioner which obtains heartbeat information, based on band frequency information of an output from a Doppler sensor directed toward an area around a heart. The air conditioner controls a power spectral density intensity LF/HF to be lower than a predetermined value.

JP-A 2006-285795 (KOKAI) discloses a monitoring system. The monitoring system performs frequency analysis on an output signal of a radio-frequency sensor. The monitoring system determines the output signal includes a respiration signal when the analyzed signal contains a low-frequency component of 1 Hz or less. The monitoring system determines the output signal includes a motion signal when the analyzed signal contains a frequency component higher than 1 Hz.

### BRIEF DESCRIPTION OF THE DRAWINGS

FIG. 1 is a block diagram showing a person-sensitive sensor according to an embodiment;

FIG. 2 is a diagram showing output data of a Doppler sensor module;

FIG. 3 is a flowchart for presuming the state of person based on an output from the sensor; and

FIG. 4 is a diagram explaining a mechanism to presume the state of person.

### DETAILED DESCRIPTION

In one embodiment, a person-sensitive sensor is provided. The person-sensitive sensor has a Doppler sensor module, a storage unit, a signal intensity comparison unit, a variance value comparison unit and a presumption unit.

The storage unit stores signal intensities of a signal outputted from the Doppler sensor module for a predetermined time period. The signal intensity comparison unit compares whether or not at least one value of the signal intensities is greater than a first threshold value. The variance value comparison unit compares whether or not a variance value of a part of the signal intensities is greater than a second threshold value. The presumption unit presumes a state of person in a space in which the person-sensitive sensor is installed, based on comparison results of the signal intensity comparison unit and the variance value comparison unit.

In another embodiment, an air conditioner is provided. The air conditioner has a person-sensitive sensor, a temperature control unit and a main body of the air conditioner. The person-sensitive sensor has a Doppler sensor module, a storage unit, a signal intensity comparison unit, a variance value comparison unit and a presumption unit.

The storage unit stores signal intensities of a signal outputted from the Doppler sensor module for a predetermined time period. The signal intensity comparison unit compares whether or not at least one value of the signal intensities is greater than a first threshold value. The variance value comparison unit compares whether or not a variance value of a part of the signal intensities is greater than a second threshold value. The presumption unit presumes a state of person in a space in which the person-sensitive sensor is installed, based on comparison results of the signal intensity comparison unit and the variance value comparison unit.

Hereinafter, further embodiments will be described with reference to the drawings

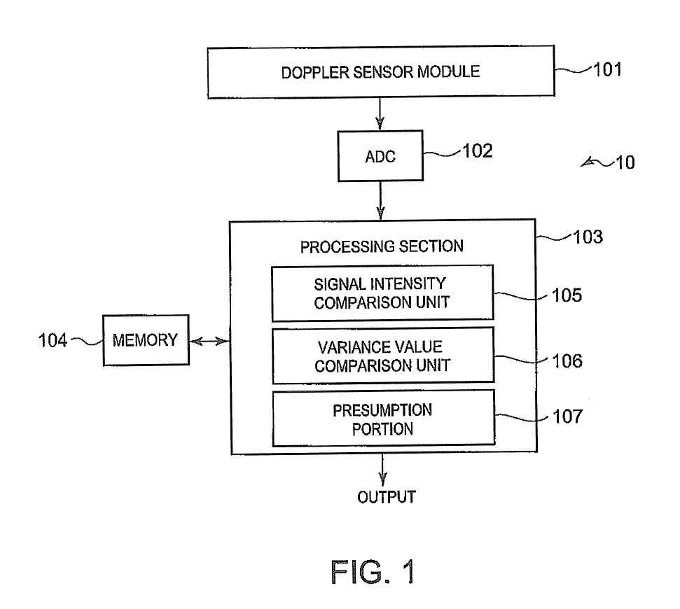

FIG. 1 shows a configuration of a person-sensitive sensor according to a further embodiment.

As shown in FIG. 1, a person-sensitive sensor 10 is provided with a Doppler sensor module 101, an analog-digital converter (hereinafter referred to as “ADC”) 102, a processing section 103, and a memory 104.

The Doppler sensor module 101 emits an electromagnetic wave such as a microwave and receives a reflected wave reflected by an object such as a person.

When the object is a movable body, the frequency of the reflected wave is different from that of the emitted electromagnetic wave, due to a Doppler effect. The object is detected based on the difference between the frequencies.

The ADC 102 samples intensity of an analog signal outputted from the Doppler sensor module 101 and converts the analog signal into a digital signal or digital output data.

The Doppler sensor module 101 and the ADC 102 can be integrated into one module.

The processing section 103 processes the output data obtained from the ADC 102. The processing section 103 has a signal intensity comparison unit 105, a variance value comparison unit 106, and a presumption unit 107.

The memory 104 is provided to store the output data from the Doppler sensor module 101, i.e., the ADC 102. The memory 104 is used to store a variance value and to store a presence/absence flag, which will be described below respectively.

The signal intensity comparison unit 105 compares whether or not at least one amplitude value of the output data of the Doppler sensor module 101 is larger than a first threshold value. The amplitude of the output data indicates a signal intensity of the output data. Considering the stability of the comparison result, it is desirable, for comparison with the first threshold value, to utilize output data produced during a predetermined period in the past and stored in the memory 104, in addition to current output data.

For example, an amplitude of the output data obtained in the past 10 seconds is compared with the first threshold value, and the amplitude of the output data is determined as greater than the first threshold value if the existence probability of the amplitude value greater than the first threshold value is 50% or more.

The first threshold value can be calculated by using a variance value of amplitudes of output data stored in the memory 104, or by using a value such as a standard deviation calculated from the variance value. For example, it is possible to use a value obtained by multiplying a variance value of amplitude of output data obtained during past 20 seconds by a predetermined value of 2.6 (=a constant of 2.0+a margin of 0.6, for example), as the first threshold value.

The variance value comparison unit 106 determines whether or not a variance value of amplitudes of output data from the Doppler sensor module 101 is larger than a second threshold value. Considering the stability of the comparison result, it is desirable, for comparison with the second threshold value, to utilize variance values of a plurality of predetermined periods in the past stored in the memory 104, in addition to a variance value during a period from a current time to a predetermined period before.

For example, a variance value of a window width of 10 seconds, which is acquired from the amplitude of output data obtained in the past 20 seconds, is compared with the second threshold value, and if the existence probability of the variance value greater than the second threshold value is 50% or more, the variance value is determined as greater than the second threshold value.

The second threshold value can be calculated by using a variance value of amplitudes of the output data stored in the memory 104, or by using a value such as a standard deviation calculated from the variance value. For example, it is possible to use a value obtained by multiplying a variance value of the amplitudes of output data obtained during the past 20 seconds by a predetermined value of 1.1 (=constant of 1.0+margin of 0.1, for example), as the second threshold value.

The presumption unit 107 sets a presence/absence flag. The presence/absence flag is set in the memory 104. The presumption unit 107 presumes the state of person in a space in which the person-sensitive sensor 10 is installed. The presumption is performed based on the comparison results of the variance value comparison unit 106 and the presence/absence flag. For example, if the variance value is determined as smaller than or equal to the second threshold value in the variance value comparison unit 106 and if the presence/absence flag indicates “absence”, it is presumed that no person is present in the space.

If the variance value is determined as greater than the second threshold value in the variance value comparison unit 106, it is presumed that a person is present in the space and the person is under movement. If the variance value is determined as smaller than or equal to the second threshold value in the variance value comparison unit 106 and if the presence/absence flag indicates presence, it is presumed that a person is present in the space and the person is under rest.

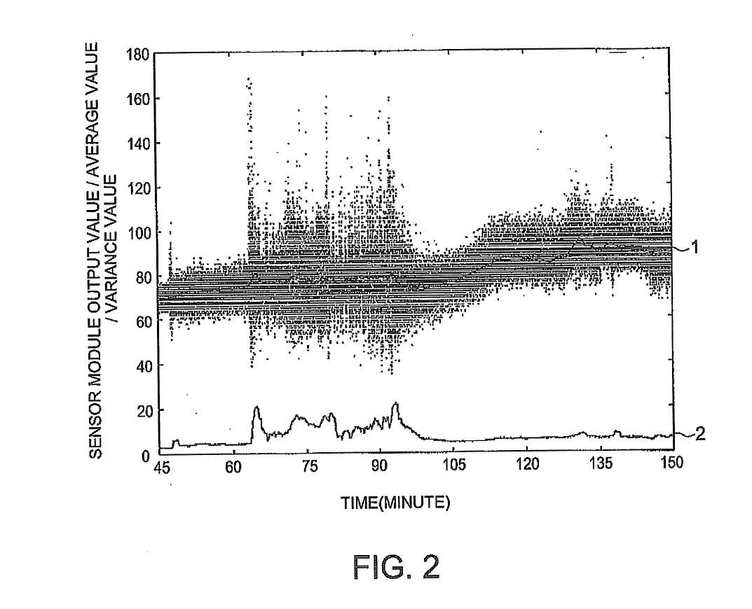

FIG. 2 is a graph showing output data of the Doppler sensor module 101. The points of FIG. 2 are shown by plotting sampled output data. The lines 1, 2 of FIG. 2 show transitions of the average value and the variance value of output data during a predetermined period in the past, graphically.

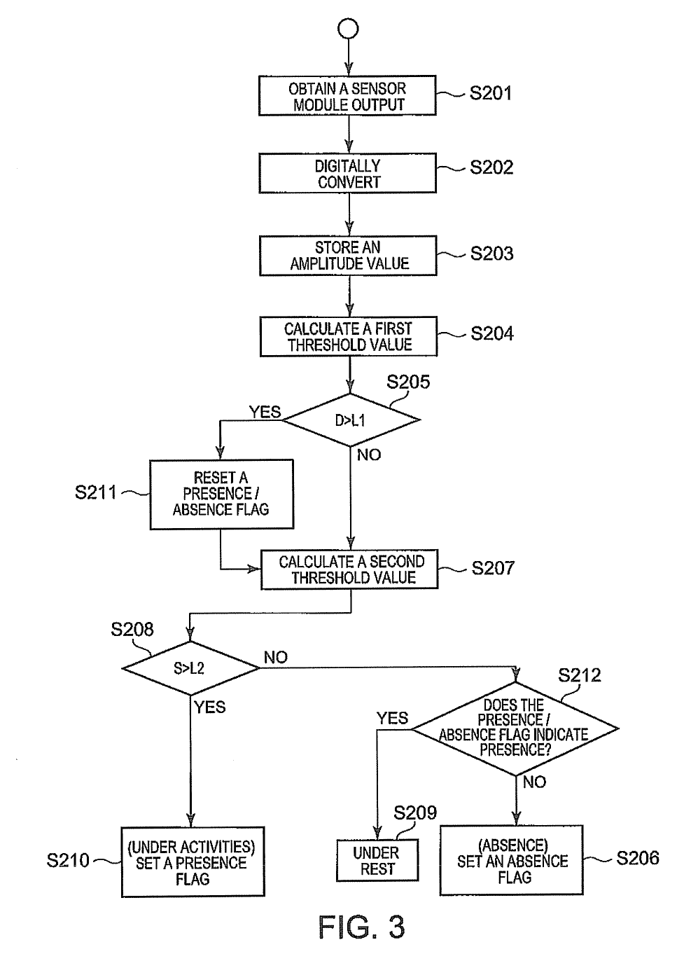

FIG. 3 is a flowchart to explain how the person-sensitive sensor 10 presumes the state of person. The ADC 102 obtains the intensity of an analog signal outputted from the Doppler sensor module 101 (Step S201). The ADC 102 samples the analog signal at a predetermined interval and converts the analog signal into a digital signal (Step S202). The processing section 103 obtains output data from the ADC 102, and stores the obtained output data in the memory 104 (Step S203).

The signal intensity comparison unit 105 reads the output data stored in the memory 104, and calculates a first threshold value (L1) from the amplitudes of the signal intensities of the output data (Step S204). The signal intensity comparison unit 105 determines whether or not at least one amplitude value (D) of the output data is greater than the first threshold value (L1) (Step S205).

If the amplitude value (D) of the output data is determined as greater than the first threshold value (L1) in the signal intensity comparison unit 105, the presumption unit 107 resets the presence/absence flag (Step S211). The reset is performed by setting “absence” for the presence/absence flag.

If the amplitude value (D) of the output data is determined as not greater than the first threshold value (L1) in the signal intensity comparison unit 105, the presence/absence flag is not reset, and the next processing is performed.

The variance value comparison unit 106 reads the output data stored in the memory 104, and calculates a second threshold value (L2) (Step S207). The variance value comparison unit 106 determines whether the variance value (5) of amplitudes of the output data is greater than the second threshold value (L2) (Step S208).

If the variance value (5) of the amplitudes of the output data is determined as greater than the second threshold value (L2) in the variance value comparison unit 106, the presumption unit 107 presumes that a person is under activities or movement (Step S210). The presumption unit 107 sets “presence” for the presence/absence flag.

If the variance value (5) of the amplitudes of the output data is determined as not greater than the second threshold value (L2), i.e., if the variance value (5) is smaller than or equal to the second threshold value (L2) in the variance value comparison unit 106, it is determined whether or not the presence/absence flag indicates “presence” (Step S212).

If the presence/absence flag indicates “presence”, the presumption unit 107 presumes that the person is under rest (Step S209). If the presence/absence flag does not indicate “presence”, i.e., indicates “absence”, the presumption unit 107 presumes that no person is present, i.e., person is absent in the space (Step S206). The presumption unit 107 sets “absence” as the presence/absence flag. The presumption unit 107 outputs the presumption result, and the processing returns to the start of the flowchart of FIG. 3.

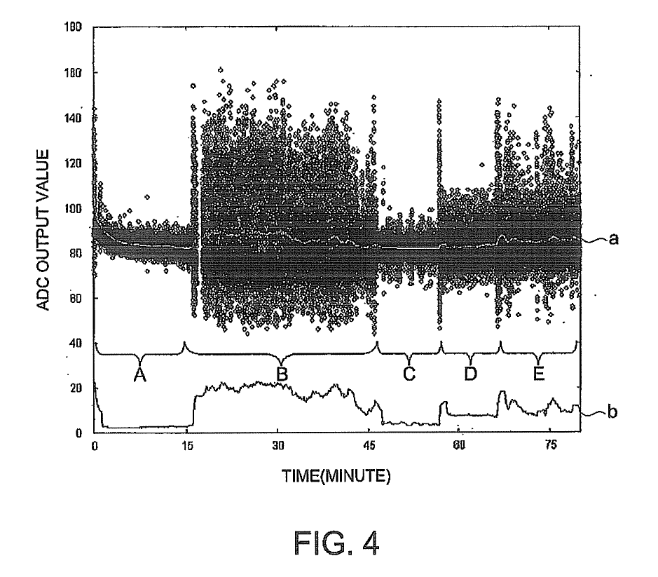

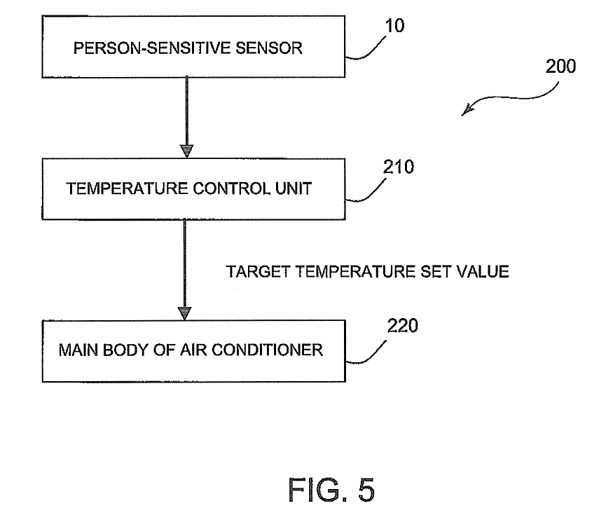

FIG. 4 is a diagram for explaining a mechanism of the person-sensitive sensor 10 to presume the state of person in a space where sensor 10 is installed.

In FIG. 4, the vertical axis indicates output data, i.e., output values, obtained from the ADC 102. The horizontal axis indicates elapse time. Each plotted mark a indicates an output value obtained from the ADC 102 at a certain time point. The line “a” that is an upper line extending horizontally indicates transition of an average of the output data during a predetermined period. The line “b” that is a lower line extending horizontally indicates transition of a variance value of the output data during a predetermined period. The areas A to E shown in FIG. 4 correspond to respective states of a space in which the person-sensitive sensor 10 is installed.

The areas A, C and D indicate the case that person is absent, i.e., no person is present, in the space where the person-sensitive sensor 10 is installed. In these areas A, C and D, the variance value of the output data from the ADC 102 is characterized as small. The areas D, E indicate the case that a machine, for example, a fan is under operation. In this case, it is characterized that, though the variance value of the output data is large, the variance value is stable because the changes of the amplitudes of the output data from the ADC 102 are small.

On the other hand, the areas B, E indicate the case that a person is present in the space where the person-sensitive sensor is installed. In the case, the variance value of the output data is characterized as large. It is also characterized that the more discontinuous and larger the motion of the person is, the more the instability of the variance value increases.

According to the embodiment, “presence” or “absence” and “activity” state of person can be determined with sufficient accuracy by using the characteristics described above and by calculating first and second threshold values using a variance value. Further, using both of the first and the second threshold values allows determining activity state of person more accurately.

The person-sensitive sensor 10 according to the embodiment can be applied to an air conditioner. As shown in FIG. 5, in an air conditioner 200, the output of the person-sensitive sensor 10 is inputted into a temperature control unit 210. The temperature control unit 210 performs temperature control of a main body 220 of the air conditioner 200 which is provided with a compressor. The temperature control is carried out by changing the setting value of a target temperature according to the output of the person-sensitive sensor 10.

It is possible to turn off the main body 220 of the air conditioner 200 based on a presumption result of the person-sensitive sensor 10, for example, when the person-sensitive sensor 10 presumes as “absence” during a predetermined time period continuously. It is also possible to set the setting temperature of the main body 220 of the air conditioner 200 to near the external temperature when the person-sensitive sensor 10 determines as “absence”. In this case, it is also possible to set the setting temperature to near a comfortable temperature, for example, 22° C. when a person is under movement, and further to set the setting temperature to a temperature between the external temperature and the comfortable temperature when a person is under rest.

The person-sensitive sensor and the air conditioner according to the embodiments do not need a large calculation cost.

While certain embodiments have been described, these embodiments have been presented by way of example only, and are not intended to limit the scope of the inventions. Indeed, the novel sensors and apparatuses described herein may be embodied in a variety of other forms; furthermore, various omissions, substitutions and changes in the form of the sensors and apparatuses described herein may be made without departing from the spirit of the inventions. The accompanying claims and their equivalents are intended to cover such forms or modifications as would fall within the scope and spirit of the inventions.

What is claimed is:

1. A person-sensitive sensor comprising:
a Doppler sensor module,
a storage unit configured to store signal intensities of a signal outputted from the Doppler sensor module for a predetermined time period,
a signal intensity comparison unit configured to compare whether or not at least one value of the signal intensities is greater than a first threshold value,
a variance value comparison unit configured to compare whether or not a variance value of a part of the signal intensities is greater than a second threshold value, and
a presumption unit configured to presume a state of person in a space in which the person-sensitive sensor is installed, based on comparison results of the signal intensity comparison unit and the variance value comparison unit.

2. The sensor according to claim 1,
wherein the variance value comparison unit obtains the comparison result based on an existence probability of the variance value of a part of the signal intensities within a predetermined time period in the past that exceed the second threshold value, and the second threshold value is a value obtained based on a variance value of the signal intensities obtained during a predetermined time period in the past.

3. The sensor according to claim 2,
wherein the signal intensity comparison unit obtains the comparison result based on an existence probability of the values of the signal intensities obtained within a predetermined time period in the past that exceed the first threshold value, and the first threshold value is a value obtained based on a variance value of the signal intensities during a predetermined time period in the past.

4. The sensor according to claim 3, wherein,
if the signal intensity comparison unit determines that the existence probability of the values of the signal intensities is greater than the first threshold value, a flag to be stored in the storage unit is set to a value indicating “absence”,
if the variance value comparison unit determines that the existence probability of the variance value is greater than the second threshold value, the presumption unit presumes that a person present in the space is under activities and sets the flag to a value indicating “presence”,
if the variance value comparison unit determines that the existence probability of the variance value is equal to or smaller than the second threshold value, and further determines that the flag indicates the value of “presence”, the presumption unit presumes that a person present in the space is under rest, and
if the variance value comparison unit determines that the existence probability of the variance value is equal to or smaller than the second threshold value, and further determines that the flag indicates the value of “absence”, the presumption unit presumes that no person is present in the space and sets the flag to the value indicating “absence”.

5. An air conditioner, comprising a person-sensitive sensor, a temperature control unit and a main body of the air conditioner, the person-sensitive sensor including:
a Doppler sensor module,
a storage unit configured to store signal intensities of a signal outputted from the Doppler sensor module for a predetermined time period,
a signal intensity comparison unit configured to compare whether or not at least one value of the signal intensities is greater than a first threshold value,
a variance value comparison unit configured to compare whether or not a variance value of a part of the signal intensities is greater than a second threshold value, and
a presumption unit configured to presume a state of person in a space in which the person-sensitive sensor is installed, based on comparison results of the signal intensity comparison unit and the variance value comparison unit.

6. The air conditioner according to claim 5,
wherein the variance value comparison unit obtains the comparison result based on an existence probability of the variance value of a part of the signal intensities within a predetermined time period in the past that exceed the second threshold value, and the second threshold value is a value obtained based on a variance value of the signal intensities obtained during a predetermined time period in the past.

7. The air conditioner according to claim 6,
wherein the signal intensity comparison unit obtains the comparison result based on an existence probability of the values of the signal intensities obtained within a predetermined time period in the past that exceed the first threshold value, and the first threshold value is a value obtained based on a variance value of the signal intensities during a predetermined time period in the past.

8. The air conditioner according to claim 7, wherein,
if the signal intensity comparison unit determines that the existence probability of the values of the signal intensities is greater than the first threshold value, a flag to be stored in the storage unit is set to a value indicating “absence”,
if the variance value comparison unit determines that the existence probability of the variance value is greater than the second threshold value, the presumption unit presumes that a person present in the space is under activities and sets the flag to a value indicating “presence”,
if the variance value comparison unit determines that the existence probability of the variance value is equal to or smaller than the second threshold value, and further determines that the flag indicates the value of “presence”, the presumption unit presumes that a person present in the space is under rest, and
if the variance value comparison unit determines that the existence probability of the variance value is equal to or smaller than the second threshold value, and further determines that the flag indicates the value of “absence”, the presumption unit presumes that no person is present in the space and sets the flag to the value indicating “absence”.
